(19) United States
(12) Patent Application Publication
(10) Pub. No.: US 2023/0166489 A1
(43) Pub. Date: Jun. 1, 2023

(54) TRANSPARENT FIRE-RETARDANT COMPOSITE MATERIAL

(71) Applicant: Madico, Inc., Pinellas Park, FL (US)

(72) Inventors: Martin J. Augustyniak, Elma, NY (US); Tadahiro Tomino, Pinellas Park, FL (US); Joseph E. Johnson, Belleair Bluffs, FL (US); Steven Sorrentino, Wakefield, MA (US)

(21) Appl. No.: 17/937,681

(22) Filed: Oct. 3, 2022

Related U.S. Application Data
(63) Continuation-in-part of application No. 17/661,489, filed on Apr. 29, 2022.
Application No. 17/661,489 is a continuation of application No. 16/703,610, filed on Dec. 4, 2019, now Pat. No. 11,345,130.
Application No. 16/703,610 is a division of application No. 15/337,971, filed on Oct. 28, 2016, now Pat. No. 11,148,405.
(60) Provisional application No. 63/261,986, filed on Oct. 1, 2021.
(60) Provisional application No. 62/314,716, filed on Mar. 29, 2016.
(60) Provisional application No. 62/247,564, filed on Oct. 28, 2015.

(51) Int. Cl. B32B 27/32; B32B 7/12; B32B 27/30; B32B 3/04; B32B 27/28; E04B 1/66; E04D 5/00; B32B 27/36; B32B 1/08; B32B 27/40; H02S 20/26; B32B 1/00; B32B 27/08; E04B 1/61; E04B 7/18; E04C 2/20; E04C 2/54; B32B 15/08

(52) U.S. Cl. CPC B32B 27/322; B32B 7/12; B32B 27/304; B32B 3/04; B32B 27/285; B32B 27/308; B32B 27/306; E04B 1/665; B32B 27/302; E04D 5/00; B32B 27/32; B32B 27/365; B32B 1/08; B32B 27/286; B32B 27/40; B32B 27/281; H02S 20/26; B32B 1/00; B32B 27/08; B32B 27/36; E04B 1/54; E04B 7/18; E04C 2/20; E04C 2/54; B32B 15/08; B32B 2307/3065; B32B 2307/416; B32B 2419/06; B32B 2607/00; B32B 2255/10; B32B 2255/26; E04B 7/10

(57) ABSTRACT

A transparent or translucent composite material, an architectural apparatus comprising the transparent or translucent composite material, and a method of manufacturing the composite material are described. The transparent or translucent composite material having a core film comprising PET, a first and second ETFE film on the outer portion, adhered via an adhesive layer configured to be fire-retardant and/or light-absorbent. The core film may have on one or both sides a solar control layer configured to block light, provide color, or other properties to the composite material.

### FIELD

The present disclosure relates to composite materials. More specifically, portions of this disclosure relate to transparent, or translucent, composite materials with sufficient strength for use as building materials.

### BACKGROUND OF THE INVENTION

Many large venues such as airports, sports stadiums, concert venues, etc. are choosing architectural materials that allow sunlight into the venue. Conventional materials for this application include ethylene tetrafluoroethylene or ETFE. ETFE is a transparent polymeric material. ETFE may be formed as a pillow or cushion shape to improve strength, or formed as a single sheet with a cable grid. ETFE has poor tensile strength and has little to no solar or thermal control.

### BRIEF SUMMARY

The present disclosure provides a composite laminate material and architectural apparatus that solves the above-stated shortcomings of the prior art.

A transparent or translucent composite material is described. The composite material comprising: a core film with a first side and a second side comprised of a polyethylene terephthalate, a first ECTFE layer on the first side of the core film, a first fire-retardant adhesive layer between the core film and the first ECTFE layer, a second ECTFE layer on the second side of the core film, a second fire-retardant adhesive layer between the second ECTFE layer and the core film, and a solar control layer between the core film and at least one of the first ECTFE layer and the second ECTFE layer. An architectural apparatus comprising the transparent or translucent composite material is also described.

In some embodiments, the solar control layer comprises a dye or colorant. Additionally, or alternatively, the solar control layer comprises a metal, metal oxide, metal salt, metal alloy, and/or dielectric material such as: aluminum, aluminum oxide, aluminum zinc oxide, chromium, copper, gold, indium tin oxide, nickel chromium, nickel vanadium, nickel vanadium oxide, silicon, silicon oxide, silicon dioxide, silver, titanium, titanium oxide, titanium nitride, tungsten, tungsten oxide, zinc, zinc sulfide, nickel alloys, and chromium alloys. In some embodiments, the solar control layer comprises nichrome and silicone oxide.

In some embodiments, one or more fire-retardants may be added to an adhesive creating a fire-retardant adhesive. In some embodiments, the fire-retardant additive contains a metal, amine, phosphate, bromine, metal oxide or hydroxide group or combination of fire retardant, such as: antimony, magnesium, tin, zinc, aluminum trihydrate, magnesium hydroxide, chlorinated paraffins, chlorinated alkyl phosphates, bis(hexachlorocyclopentadiene)cyclooctane (dechlorane plus), hexachlorocyclopentadienyl-dibromocyclooctane (HCDBCO), tris(2-chloroethyl)phosphate (TCEP), polybrominated diphenyl ethers (PBDE), hexabromocyclododecane (HBCD), hexamethylphosphoramide (HMPA), tetrabromobisphenol A (TBBPA), tris(2-butoxyethyl) phosphate (TBOEP), tripentyl phosphate (TPP), tris(2,3-dibromopropyl) phosphate (TDB99), phenyl propan-2-yl hydrogen phosphate (PPHP), melamine polyphosphate (MPP), phosphonate flame retardants such as Methyl (5-methyl-2-methyl-1,3,2-dioxaphosphorinan-5-y) Ester, Tetrabromophthalate Diol & TCPP 80:20 blend, Tetrabromophthalate Diol & TCPP 50:50 blend 2,4,6-Tris(2,4,6-tribromophenoxy)-1,3,5-triazine, Tris (Tribromoneopentyl) Phosphate, Ethylene Bis Tetrabromophthalimide, Poly (2,3 dibromo methylpropyl ether), Tetrabromophthalate Diol, Poly (2,6 Dibromophenylene Oxide), Oligomer of Tetrabromobisphenol A, Brominated Polystyrene, Dibromoneopentyl Glycol, and combinations thereof. In some embodiments, the first fire-retardant adhesive and the second fire-retardant adhesive further comprise an ultraviolet absorber additive.

A method of manufacturing the transparent or translucent composite material is also described. The method includes: providing a PET film core film, having a first side and a second side, applying a solar control layer on the first side of the PET film, laminating a first ECTFE film to the first side of the PET film using a first fire-retardant adhesive, and laminating a second ECTFE film to the second side of the PET film using a second fire-retardant adhesive.

In some embodiments, a second solar control layer is applied to the second side of the PET film prior to laminating the second ECTFE film to the PET film. The solar control layer may be applied via sputtered coating, thermal evaporation coating, and or electron beam coating. In some embodiments, the first and second ECTFE film is corona treated prior to laminating to the PET film.

### BRIEF DESCRIPTION OF THE DRAWINGS

The drawings described herein are for illustrative purposes for selected embodiments and not all possible implementations, and are not intended to limit the scope of the present disclosure.

FIG. 1A illustrates the composite film layers in accordance with an embodiment of the present invention.

FIG. 1B illustrates the composite film layers in accordance with an embodiment of the present invention,

FIG. 2 is a process flow diagram for a method of manufacturing the composite materials in accordance with an embodiment of the present invention.

FIG. 3 shows the light absorption in the 280 to 2500 nanometer range for a composite material in accordance with an embodiment of the present invention.

FIG. 4 shows the light absorption in the 300 to 400 nanometer range for a composite material in accordance with an embodiment of the present invention.

FIG. 5A shows the elongation at break in the machine direction of the composite material in accordance with an embodiment of the present invention.

FIG. 5B shows the elongation at break in the transverse direction of the composite material in accordance with an embodiment of the present invention.

FIG. 5C shows the tensile strength in the machine direction of the composite material in accordance with an embodiment of the present invention.

FIG. 5D shows the tensile strength in the transverse direction of the composite material in accordance with an embodiment of the present invention.

FIG. 5E shows the Young's Modulus in the machine direction of the composite material in accordance with an embodiment of the present invention.

FIG. 5F shows the Young's Modulus in the transverse direction of the composite material in accordance with an embodiment of the present invention.

### DETAILED DESCRIPTION OF EMBODIMENTS OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

It must be noted that, as used in the specification and the appended claims, the singular forms “a,” “an” and “the” include plural referents unless the context clearly dictates otherwise.

The term ‘or” as used herein, with respect to a list of two or more items, elements, components, or materials, is not indicative of a complete disjunction such that the listed items, elements, components, or materials are mutually exclusive of each other. For example, “X, Y, or Z” does not mean that each of X, Y, Z are mutually exclusive of each other. Two or more of X, Y, Z could partially or completely overlap each other or that at least one of X, Y, or Z could be included in or be a subgenus of at least one of another of X, Y, or Z. As another example, “cells may be grown in monolayer, three dimensions, or on beads” does not mean that cells grown on beads does not include cells grown in three dimensions. As a further example, “at least one of a biocompatible solvent; a bioresorbable solvent; or ethyl lactate” does not mean that ethyl lactate nor a solvent including ethyl lactate is neither a biocompatible solvent nor a bioresorbable solvent; nor does it mean that a biocompatible solvent or a bioresorbable solvent cannot be or include ethyl lactate.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range or the characteristics being described.

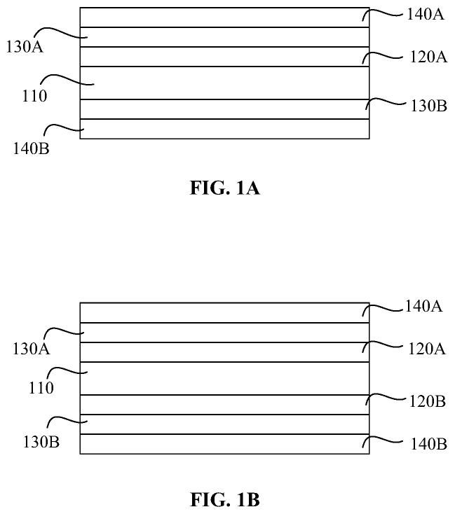

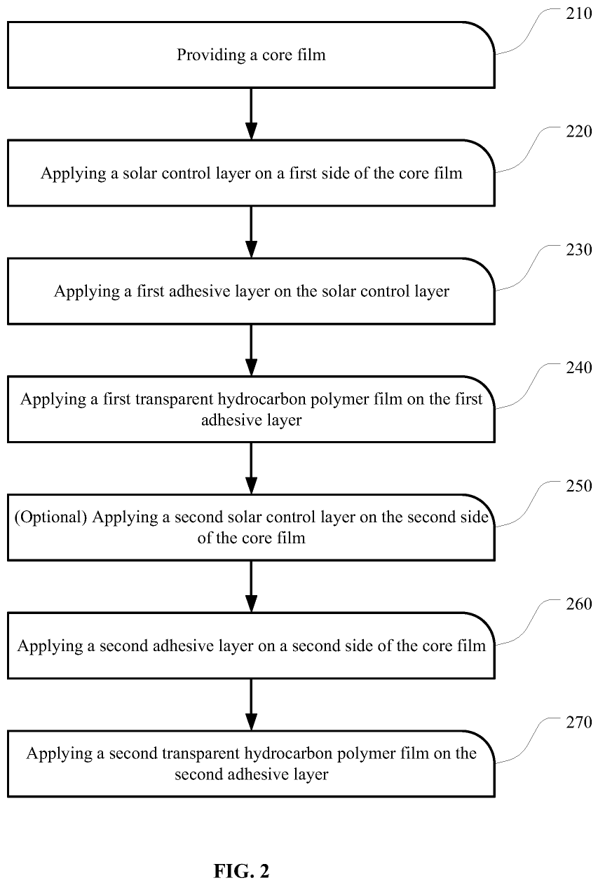

A multilayer composite material is described herein with reference to FIGS. 1-3. As shown in FIG. 1A the composite material may include six layers. At the center of the composite material is a core film layer 110 having a first side and a second side. The first side may have a solar control layer 120A followed by a fire-retardant adhesive layer 130A and an ECTFE film layer 140A. On the second side of the core film 110 may have a second fire-retardant adhesive layer 130B followed by a second ECTFE layer 140B. Alternatively, as shown in FIG. 1B, the composite material may have two solar control layers a first solar control layer 120A and a second solar control layer 120B. In this embodiment, the first side of the core film 110 has a first solar control layer 120A followed by a fire-retardant adhesive layer 130A and an ECTFE film layer 140A; and the second side of the core film 110 has a second solar control layer 120B, followed by a second fire-retardant adhesive layer 130B, and a second ECTFE film layer 140B.

Each of the ECTFE film layers 140A and 140B may be about 60 μm to about 140 μm. In some embodiments, the ECTFE film layers 140A and 140B may be about 80 μm to about 120 μm. Additionally, or alternatively, the ECTFE film layers 140A and 140B may be about 90 μm to about 110 μm. In some embodiments, ECTFE film layers 140A and 140B may be about 90 μm to about 100 μm. In some embodiments, the ECTFE film layers 140A and 140B are approximately 4 mils, or 101.6 μm.

Each of the fire-retardant adhesive layers 120 A and 120B may be about 5 μm to about 40 μm. In some embodiments, the fire-retardant adhesive layers 120 A and 120B may be about 7.5 μm to about 30 μm. Additionally, or alternatively, the fire-retardant adhesive layers 120 A and 120B may be about 10 μm to about 25 μm. In some embodiments, the fire-retardant adhesive layers may be about 15 μm to about 20 μm.

The thickness of the core film may be determined based on various material properties, such as Young's modulus, flexural modulus, ultimate tensile strength, light transparency, light translucency, among others. The core film 110 may be about 25 μm to about 250 μm. In some embodiments, the core film 110 may be about 25 μm to about 100 μm. Additionally, or alternatively, the core film 110 may be about 25 μm to about 75 μm. In some embodiments, the core film 110 may be about 25 μm to about 50 μm. In some embodiments, the core film 110 may be about 50 μm to about 150 μm. In some embodiments, the core film 110 may be about 50 μm to about 100 μm. In some embodiments, the core film 110 may be about 75 μm to about 200 μm. In some embodiments, the core film 110 may be about 75 μm to about 100 μm. In some embodiments, the core film 110 may be about 100 μm to about 200 μm. In some embodiments, the core film 110 may be greater than 50 μm. In some embodiments, the core film 110 may be greater than 100 μm. In some embodiments, the core film 110 may be greater than 150 μm. In some embodiments, the core film 110 may be less than 2 mm. In some embodiments, the core film 110 may be less than 800 μm. In some embodiments, the core film 110 may be less than 500 μm. Additionally, or alternatively, the core film 110 may be 6.5 mil or 165 μm.

The composite material described herein may be used for various applications, including but not limited to: architectural material, residential windows and window systems, vehicle windows and window systems, greenhouses, chemical fume hoods, and others.

PET Core Film

The core film is configured to provide the composite material with strength (e.g., higher Young's modulus, flexural modulus, ultimate tensile strength) to the composite material. The mechanical properties of the composite material may be further tuned by varying the thickness of the core film layer. The core film may exhibit a Young's modulus of greater than 500 MPa, greater than 1000 MPa or greater than 4000 MPa and visible light transmission of greater than 40%, greater than 90%, greater than 95% or greater than 99% for a core film having a minimal thickness of 100 The core film should not substantially compromise the overall transparency or translucency of the composite material

The core film may be polyethylene terephthalate (PET). PET exhibits a Young's Modulus of approximately 2000 MPa to about 4000 MPa, a flexural modulus of approximately 8.3 GPa to about 14 GPa, and an ultimate tensile strength of approximately 60 MPa to about 140 MPa.

Solar Control Layer

The solar control layer of the composite material may be configured to block desired wavelengths or wavelength ranges of light and/or heat. For example, it may be desirable to block wavelengths in the infrared spectrum (780 nm to 2500 nm). In another example, the ultraviolet and/or visible light may also be blocked. Additionally, or alternatively, the solar control layer may be configured to tailor the transparency and/or translucency of the composite material. In some embodiments, the solar control layer is configured to provide the composite material with a specific color. In some embodiments, the solar control layer may include dyes or pigments to impart a desired color to the composite material. Additionally, or alternatively, the material may be configured to be reflective. In some embodiments, the material is configured to reflect a certain wavelength or range of wavelengths. The optical properties of the composite material may be tuned by varying the components and thickness of the solar control layer.

The solar control layer may comprise metals, metal oxides, metal salts, metal alloys, and/or dielectric materials depending on the desired properties. For example the solar control layer may comprise aluminum, aluminum oxide, and/or aluminum zinc oxide. In another example, the solar control layer may comprise chromium, nickel chromium, and/or chromium oxide. In another example, the solar control layer may comprise silicon, silicon oxides, and/or silicon dioxide. In another example, the solar control layer may comprise nickel, nickel vanadium, nickel vanadium oxide, and/or other nickel alloys. Other examples of metals, metal salts, metal alloys, and metal oxides that may be in the solar control layer include: copper, gold, indium, indium tin oxide, zinc, zinc oxide, zinc sulfide, titanium, titanium oxide, titanium nitride, tungsten, tungsten oxide, and/or silver. Other examples of dielectric materials that may be suitable as a component of the solar control layer include: glass, PTFE, polyimide, polyethylene, polyimide, polystyrene, titanium dioxide, strontium titanate, barium strontium titanate, barium titanate, calcium copper titanate, conjugated polymeric materials, and combinations thereof.

The solar control layer may comprise multiple layers. For example, the solar control layer may comprise a metal alloy layer, such as nichrome, and a further coat of silicone oxides. In some embodiments, the solar control layer is a hydrocarbon polymeric material with dyes, metals, metal oxides, metal salts, metal alloys, and/or dielectric materials embedded therein. In one example, the solar control layer is metallized PET.

In some embodiments, the solar control layer is one or more of the coatings described in U.S. Pat. No. 11,364,708, the entire disclosure of which, except for any definitions, disclaimers, disavowals, and inconsistencies, is incorporated herein by reference.

ECTFE Film

The external film for use in the composite material described herein should have sufficient transparency, or translucency, to allow light to pass through the composite material. Additionally, the material chosen for this film should have desired fire-retardant properties.

Compared to other fluorinated hydrocarbon polymer films, such as ETFE, ECTFE is less flammable while maintaining transparency, chemical resistance, and other desired properties when used in the composite material described herein.

Fire-Retardant Adhesive Composition

The fire-retardant adhesive comprises a resin with a fire-retardant additive. Additional additives may endow the adhesive with thermal stability, and/or UV-protection. The resin used in the adhesive may include acrylates, cyanoacrylates, epoxide resins, polyester resins, mercaptopropyl trimethoxy silane, isocyanate resins, polyurethane, polyimide, combinations and the like.

The fire-retardant additive may be antimony, magnesium, tin, zinc, aluminum trihydrate, magnesium hydroxide, chlorinated paraffins, chlorinated alkyl phosphates, bis(hexachlorocyclopentadiene)cyclooctane (dechlorane plus), hexachlorocyclopentadienyl-dibromocyclooctane (HCDBCO), tris(2-chloroethyl)phosphate (TCEP), polybrominated diphenyl ethers (PBDE), hexabromocyclododecane (HBCD), hexamethylphosphoramide (HMPA), tetrabromobisphenol A (TBBPA), tris(2-butoxyethyl) phosphate (TBOEP), tripentyl phosphate (TPP), tris(2,3-dibromopropyl) phosphate (TDB99), phenyl propan-2-yl hydrogen phosphate (PPHP), melamine polyphosphate (MPP), Methyl (5-methyl-2-methyl-1,3,2-dioxaphosphorinan-5-y) Ester, Tetrabromophthalate Diol & TCPP 80:20 blend, Tetrabromophthalate Diol & TCPP 50:50 blend 2,4,6-Tris(2,4,6-tribromophenoxy)-1,3,5-triazine, Tris (Tribromoneopentyl) Phosphate, Ethylene Bis Tetrabromophthalimide, Poly (2,3 dibromo-2-methylpropyl ether), Tetrabromophthalate Diol, Poly (2,6 Dibromophenylene Oxide), Oligomer of Tetrabromobisphenol A, Brominated Polystyrene, Dibromoneopentyl Glycol, and combinations thereof. The selection of the fire-retardant additives into an adhesive are not inherently obvious or known, including non-interference of the polymer curing process, non-degradation of fire-resistance upon exposure to high curing temperatures (typically over 200 degrees F.), non-interaction with other adhesive components like the resin, resin hardener, ultraviolet and other additives, and non-interference in adhesive bonding to the film layers—ECFE, PET and metal of the metallized PET, while being optically transparent and colorless.

The adhesive composition may further comprise an ultraviolet absorber (UVA). As used herein, the term ultraviolet absorber refers to any additive compound that absorbs ultraviolet light. Examples of UVAs include, but are not limited to: benzophenones, benzotriazoles, hindered amine light stabilizers (HALS), titanium oxide, nickel quenchers, cyanoacrylates, carbon black, hydroxybenzophenones, hydroxyphenyl benzotriazoles, rutile titanium oxide, oxanilides, benzotriazoles, hydroxyphenyl triazines, and combinations thereof.

It is important that the adhesive, and its additives, not compromise the transparency of the overall composite material while maintaining excellent adhesive properties.

Fire/Flame Retardant

The composite material described herein is fire and flame retardant. Flame retardant material is required for many applications including but not limited to architectural applications as described herein. The composite material may have a UL 94 VTM rating of VTM-0.

The composite material described herein, when subjected to a “Test for Surface Burning Characteristics of Building Materials” (ASTM E84) has a CFS (Calculated Flame Speed) of 0.00, a FSI (Flame Spread Index) of 0, CSD (Calculated smoke developed) of 60.2, and an SDI (Smoke Developed Index) of 60. Likewise, when the composite material is observed in a Class A Spread of Flame Test, no significant lateral spread of flame from the path directly exposed to test flame, no portion of the material was blown of fell off of the test deck in the form of flaming or glowing brands, the material did not break, slide, crack, or warp when exposed to the flame, and no portion of the material fell away in the form of glowing particles.

Light and Heat

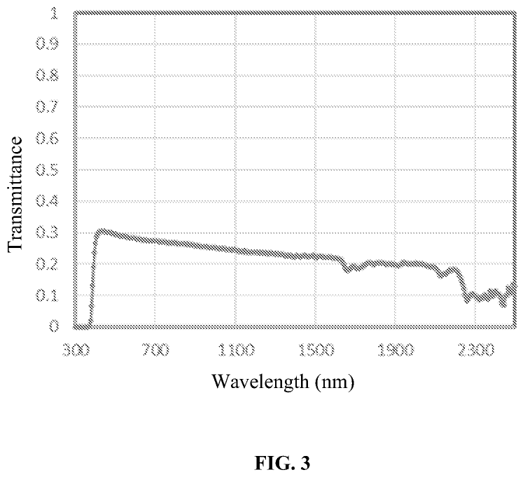

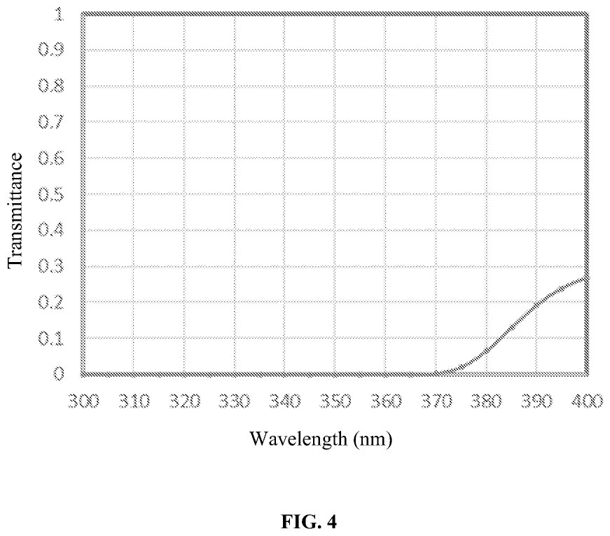

In some embodiments, the solar control layer is configured to provide the composite material with an infrared rejection of 80% (as determined by ASTM E903-12). Additionally, or alternatively, the solar control layer may be tuned to provide the composite material with a specific solar heat gain coefficient (SHGC). The SHGC is the fraction of solar radiation admitted through a material. In some embodiments, the SHGC is approximately 0.10 to about 0.90 (as determined by ASTM E903-12). In some embodiments, the SHGC is approximately 0.30 to about 0.45 (as determined by ASTM E903-12). Additionally, or alternatively, the visible light transmission can be varied or tuned from 3% to 90%. The optical properties of the composite material can be tuned. For example, the four examples in Table 1 show varied optical properties. The visible light transmission can be varied, so that solar properties may be varied ex solar heat gain coefficient-meaning different amounts and wavelengths of light may be blocked or pass through—unlike other films; the films maintain transparency. FIGS. 3 and 4 show light spectra of the composite material described herein.

TABLE 1

| | Example | Example | Example | Example |
|---|---|---|---|---|
| | 1 | 2 | 3 | 4 |
| Shading Coefficent | 1.02 | 0.70 | 0.44 | 0.18 |
| Total Solar Energy | 11.3% | 39.1% | 61.7% | 84.3% |
| Rejection | | | | |
| Solar Reflection | 7.4/7.4 | 12.2/9.3 | 27.0/23.0 | 55.4/51.6 |
| (Ext/Int) | | | | |
| Solar Absorbance | 5.7% | 38.8% | 47.7% | 41.5% |
| Solar Transmission | 86.9% | 49.0% | 25.5% | 3.2% |
| Visible Light | 8.3/8.3 | 12.1/9.1 | 26.0/22.0 | 52.7/49.6 |
| Reflection (Ext/Int) | | | | |
| Visible Light | 89.2% | 52.3% | 28.7% | 3.1% |
| Transmission | | | | |
| Solar Heat | 0.89 | 0.61 | 0.39 | 0.16 |
| Coefficent (SHGC) | | | | |
| Luminous | 0.87 | 0.74 | 0.65 | 0.17 |
| Efficacy (LE) | | | | |
| IR rejection | 19.0% | 58.0% | 80.0% | 97.0% |
| Summer Glass | 88.5 | 104 | 109.5 | 105.2 |
| Temperature (F.) | | | | |

Mechanical Properties

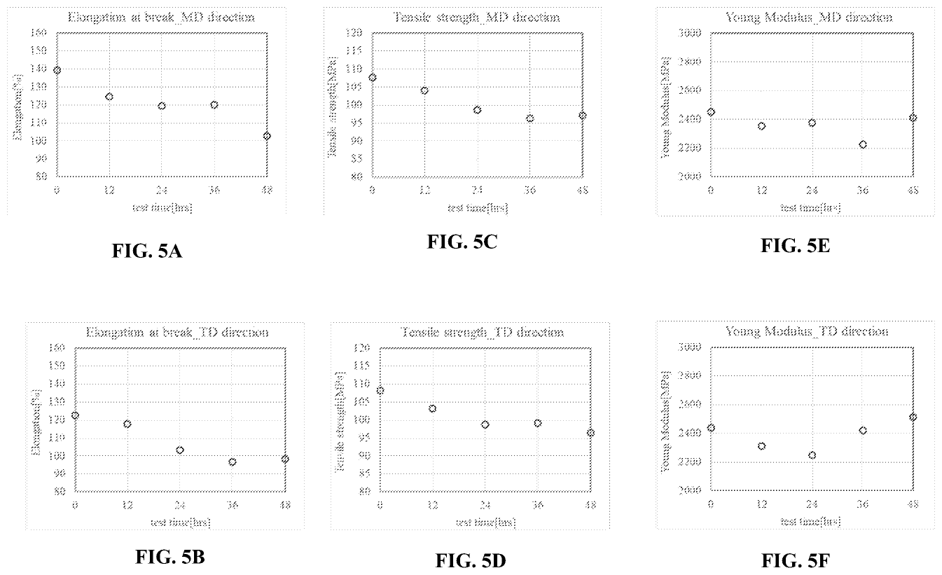

The composite material described herein may have a tensile strength at break of approximately 100 MPa to about 120 MPa (as determined by ASTM D882-10). In some embodiments, the composite material has a tensile strength at break of approximately 110 MPa, as illustrated in FIGS. 5C and 5D.

The composite material described herein may have an elongation at break of approximately 90% to about 170% (as determined by ASTM D882-10). In some embodiments, the elongation at break is approximately 130% as illustrated in FIGS. 5A and 5B.

The composite material described herein may have a Young's Modulus of approximately 2250 MPa to about 2650 MPa. In some embodiments, the Young's Modulus of a composite material is approximately 2450 MPa, as illustrated in FIGS. 5E and 5F.

Architectural Apparatus

The composite material described herein may be used as an architectural material. The architectural material may be used to form ceilings and/or vertical walls. When used as architectural material, the composite material may be formed into desired shapes and/or sizes and securely connected via a clamping system. In some embodiments, the clamping system is as described in U.S. Pat. No. 11,345,130, the entire disclosure of which, except for any definitions, disclaimers, disavowals, and inconsistencies, is incorporated herein by reference. In some embodiments the composite material is formed into pillows or cushions.

Method of Manufacture

The composite material described herein may be formed by first providing a core film. The core film may be extruded into a film using a roll drum. Once the core film is obtained, the solar control layer is applied. The solar control layer may be applied via coating, spraying, vapor deposition, sputtered coating, thermal evaporation coating, and/or electron beam coating. In an embodiment where there are multiple components in the solar control layer, the components of the solar control layer may be applied individually or after mixing.

Once the solar control layer is applied to the core film, the first ECTFE film is laminated to the first side of the core film with the first fire-retardant adhesive layer. This is followed by the lamination of the second ECTFE film to the second side of the core film with the second fire-retardant adhesive layer. In some embodiments the first and second ECTFE film layers are laminated simultaneously. Optionally, a second solar control layer may be applied to the second side of the core film prior to the lamination of the first ECTFE film and/or the second ECTFE film. In some embodiments, the first ECTFE film and the second ECTEF film are corona-treated prior to application to the core film.

In one example, a core film of PET is coated on a first side with Nichrome and silicon oxides to obtain a coated core film. A first ECTFE film is corona treated, prior to laminating to the first side of the coated core film with a fire-retardant adhesive. Once the first side is laminated with the first ECTFE layer, the second side of the coated core film can be laminated in the same manner.

In some embodiments, the first ECTFE film and the second ECTFE film are coated with an adhesive and film for protection during shipping. This protective film is configured to be removed from the surface, along with the adhesive, once the composite material is ready for use.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A transparent or translucent composite material comprising
a core film having a first side and a second side, comprising polyethylene terephthalate;
a first ECTFE layer on the first side of the core film;
a first fire-retardant adhesive layer between the first ECTFE layer and the first side of the core film;
a second ECTFE layer on the second side of the core film;
a second fire-retardant adhesive layer between the second ECTFE layer and the second side of the core film; and
a solar control layer intermittent the core film and at least one of the first ECTFE layer the second ECTFE layer.

2. The transparent or translucent composite material according to claim 1, wherein the solar control layer comprises at least one metal, metal oxide, metal salt, metal alloy, or dielectric material.

3. The transparent or translucent composite material according to claim 2, wherein the solar control layer comprises Nichrome and silicon oxides

4. The transparent or translucent composite material according to claim 1, wherein the first fire-retardant adhesive and the second fire-retardant adhesive comprises one or more fire-retardant additives.

5. The transparent or translucent composite material according to claim 4, wherein the fire-retardant additive is selected from the group consisting of: antimony, magnesium, tin, zinc, aluminum trihydrate, magnesium hydroxide, chlorinated paraffins, chlorinated alkyl phosphates, bis(hexachlorocyclopentadiene)cyclooctane (dechlorane plus), hexachlorocyclopentadienyl-dibromocyclooctane (HCDBCO), tris(2-chloroethyl)phosphate (TCEP), polybrominated diphenyl ethers (PBDE), hexabromocyclododecane (HBCD), hexamethylphosphoramide (HMPA), tetrabromobisphenol A (TBBPA), tris(2-butoxyethyl) phosphate (TBOEP), tripentyl phosphate (TPP), tris(2,3-dibromopropyl) phosphate (TDB99), phenyl propan-2-yl hydrogen phosphate (PPHP), melamine polyphosphate (MPP), Methyl (5-methyl-2-methyl-1,3,2-dioxaphosphorinan-5-y) Ester, Tetrabromophthalate Diol & TCPP 80:20 blend, Tetrabromophthalate Diol & TCPP 50:50 blend 2,4,6-Tris(2,4,6-tribromophenoxy)-1,3,5-triazine, Tris (Tribromoneopentyl) Phosphate, Ethylene Bis Tetrabromophthalimide, Poly (2,3 dibromo-2-methylpropyl ether), Tetrabromophthalate Diol, Poly (2,6 Dibromophenylene Oxide), Oligomer of Tetrabromobisphenol A, Brominated Polystyrene, Dibromoneopentyl Glycol, and combinations thereof.

6. The transparent or translucent composite material according to claim 1, wherein the first fire-retardant adhesive and the second fire-retardant adhesive comprises an ultraviolet absorber additive.

7. An architectural apparatus comprising:
a transparent or translucent composite material comprising:
a core film having a first side and a second side, comprising polyethylene terephthalate;
a first ECTFE layer on the first side of the core film;
a first fire-retardant adhesive layer between the first ECTFE layer and the first side of the core film;
a second ECTFE layer on the second side of the core film;
a second fire-retardant adhesive layer between the second ECTFE layer and the second side of the core film; and
a solar control layer intermittent the core film and at least one of the first ECTFE layer the second ECTFE layer.

8. The architectural apparatus according to claim 7, wherein the solar control layer comprises at least one metal, metal oxide, metal salt, metal alloy, or dielectric material.

9. The architectural apparatus according to claim 8, wherein the solar control layer comprises Nichrome and silicon oxides

10. The architectural apparatus according to claim 7, wherein the first fire-retardant adhesive and second fire-retardant adhesive comprises one or more fire-retardant additives.

11. The architectural apparatus according to claim 10, wherein the fire-retardant additive is selected from the group consisting of: antimony, magnesium, tin, zinc, aluminum trihydrate, magnesium hydroxide, chlorinated paraffins, chlorinated alkyl phosphates, bis(hexachlorocyclopentadiene)cyclooctane (dechlorane plus), hexachlorocyclopentadienyl-dibromocyclooctane (HCDBCO), tris(2-chloroethyl)phosphate (TCEP), polybrominated diphenyl ethers (PBDE), hexabromocyclododecane (HBCD), hexamethylphosphoramide (HMPA), tetrabromobisphenol A (TBBPA), tris(2-butoxyethyl) phosphate (TBOEP), tripentyl phosphate (TPP), tris(2,3-dibromopropyl) phosphate (TDB99), phenyl propan-2-yl hydrogen phosphate (PPHP), melamine polyphosphate (MPP), Methyl (5-methyl-2-methyl-1,3,2-dioxaphosphorinan-5-y) Ester, Tetrabromophthalate Diol & TCPP 80:20 blend, Tetrabromophthalate Diol & TCPP 50:50 blend 2,4,6-Tris(2,4,6-tribromophenoxy)-1,3,5-triazine, Tris (Tribromoneopentyl) Phosphate, Ethylene Bis Tetrabromophthalimide, Poly (2,3 dibromo-2-methylpropyl ether), Tetrabromophthalate Diol, Poly (2,6 Dibromophenylene Oxide), Oligomer of Tetrabromobisphenol A, Brominated Polystyrene, Dibromoneopentyl Glycol, and combinations thereof.

12. The architectural apparatus according to claim 7, wherein the first fire-retardant adhesive and the second fire-retardant adhesive comprises an ultraviolet absorber additive.

13. A method of manufacturing a composite material comprising the steps of:
providing a PET film having a first side and a second side,
applying a solar control layer on the first side of the PET film,
laminating a first ECTFE film to the first side of the PET film using a first fire-retardant adhesive, and
laminating a second ECTFE film to the second side of the PET film using a second fire-retardant adhesive.

14. The method of manufacturing a composite material according to claim 13, further comprising, prior to laminating the second ECTFE film to the second side of the PET film, applying a second solar control layer on the second side of the PET film.

15. The method of manufacturing a composite material according to claim 13, wherein applying the solar control layer comprises sputtered coating, thermal evaporation coating, and/or electron beam coating.

16. The method of manufacturing a composite material according to claim 13, further comprising:
corona-treating the first ECTFE film, prior to laminating the first ECTFE film to the first side of the PET film using a fire-retardant adhesive; and
corona-treating the second ECTFE film, prior to laminating the second ECTFE film to the first side of the PET film using a fire-retardant adhesive.
